(19) United States
(12) Patent Application Publication
(10) Pub. No.: US 2004/0078580 A1
(43) Pub. Date: Apr. 22, 2004

(54) Antivirus network system and method for handling electronic mails infected by computer viruses

(75) Inventors: Chen-Lung Hsu, Taipei (TW); Wei-Chung Lee, Taipei (TW); Jeremy Liang, San Jose, CA (US); Li Li Ho, Taipei (TW); Chun-Yen Lin, Cupertino, CA (US); Chih-Hsin Tseng, Shijr City (TW)

Correspondence Address: Ya-Chiao Chang, BAKER & McKENZIE, 15F., 168 Tun Hwa N. Rd., Taipei, 105, TW

(73) Assignee: Trend Micro Incorporated

(21) Appl. No.: 10/277,192

(22) Filed: Oct. 18, 2002

(51) Int. Cl. H04L 9/32

(52) U.S. Cl. 713/188

(57) ABSTRACT

The invention generally provides an antivirus network system and method for handling electronic mails (e-mails) infected by computer viruses in a network having a plurality of device nodes receiving and transmitting e-mails through a gateway server. A preferred embodiment of the method according to the invention primarily comprises the steps of determining if any of the e-mails are infected by computer viruses, attaching flags to the infected e-mails, transporting the e-mails, including the infected e-mails, through the gateway server, identifying the infected e-mails through the attached flags, and performing antivirus actions on the identified e-mails, where these process steps are performed transparently to the plurality of device nodes. The method according to the invention can further include the step of processing the infected e-mails according to instructions in the attached flags, where the instructions further include deleting, blocking and quarantining the infected e-mails.

### BACKGROUND OF THE INVENTION

1. Field of the Invention

The invention claimed in the present patent application generally relates to an antivirus system and method in a network and, more particularly, to an antivirus system and method in a network for handling electronic mails infected by computer viruses.

2. Description of the Related Art

The Internet is an ideal mass medium for the spread of computer viruses since virtually every computer needs to be connected to another computer or network either directly or indirectly. The Internet, with all its benefits and fascinations, is nonetheless an effective and efficient medium for an intentional spread of malicious code attack. It has been estimated that some fast-paced viruses can spread throughout the entire Internet within a matter of a couple of hours if not effectively stopped. For any network environment, be it the Internet, a metropolitan area network (MAN), a wide area network (WAN), a local area network (LAN) or even wireless communications networks for mobile phones and personal digital assistant (PDA) devices, the more data transmitted and the more services offered, the more likely viruses are able to infect those networks.

A primary objective for network management is directed to preventing computer viruses entering into a network through electronic mails (or e-mails). A standard antivirus practice is deploying antivirus software programs in the device nodes and servers within the network. The antivirus programs regularly scan the stored data within the network for computer viruses at the database level. However, shortcomings are inherent in this standard practice in the art, such as delays in detecting computer viruses that may already have entered into the servers or device nodes of the network as stored data. Since the antivirus programs are deployed at the receiving end of the e-mailed data, the mail-borne viruses may already have inflicted significant damage as they pass through the mail gateway into the network. Moreover, antivirus programs operating at the database level are generally impotent against e-mail spamming at the gateway level. These and other shortcomings in the art become exacerbated as the topologies of the network become more complex and the volume of inbound and outbound e-mails becomes increasingly large.

There is thus a general need in the art for an optimal network architecture that overcomes at least the aforementioned shortcomings in the art. In particular, a need exists in the art for an antivirus system and method for a network having a plurality of devices receiving and transmitting e-mails through a mail gateway that may be infected by computer viruses.

### SUMMARY OF THE INVENTION

The invention generally provides an antivirus network system and method for handling electronic mails (e-mails) infected by computer viruses in a network having a plurality of device nodes receiving and transmitting e-mails through a gateway server. A preferred embodiment of the method according to the invention primarily comprises the steps of determining if any of the e-mails are infected by computer viruses, attaching flags to the infected e-mails, transporting the e-mails, including the infected e-mails, through the gateway server, identifying the infected e-mails through the attached flags, and performing antivirus actions on the identified e-mails, where these process steps are performed transparently to the plurality of device nodes. The method according to the invention can further include the step of processing the infected e-mails according to instructions in the attached flags, where the instructions further include deleting, blocking and quarantining the infected e-mails.

A preferred embodiment of the network system according to the invention comprises a mail server having a mail gateway a plurality of device nodes receiving and transmitting electronic mails (e-mails) through the mail gateway, a computer virus scanner in the mail server scanning the e-mails to determine if any of the e-mails are infected by computer viruses, a virus scanning control attaching flags to the infected e-mails and causing the infected e-mails to be transported through the mail gateway, a gateway scanner in the mail gateway identifying the infected e-mails through the attached flags and performing antivirus actions on the identified e-mails, where the antivirus actions are performed transparently to the plurality of device nodes in the network system. The network system according to the invention can further include a database storing the infected e-mails. The attached flags can further comprise a plurality of instructions, where the antivirus actions on the identified e-mails are performed according to these instructions. The plurality of instructions can further comprise subactions including deleting, blocking and quarantining the identified e-mails.

### BRIEF DESCRIPTION OF THE DRAWINGS

The foregoing features and advantages of the invention will become more apparent in the following Detailed Description when read in conjunction with the accompanying drawings (not necessarily drawn to scale), in which:

FIG. 1 is a block diagram generally illustrating an antivirus methodology for handling electronic mails (e-mails) in a network according to the invention;

FIG. 2 is a block diagram generally illustrating a network connected to the Internet having a mail server for handling e-mails for a plurality of device nodes according to the invention;

FIG. 3 is a block diagram illustrating an exemplary mail server for handling e-mails infected by computer viruses in a network according to the invention;

FIG. 4 is a flow diagram illustrating a particular embodiment of the antivirus method for handling e-mails a network in accordance with the invention; and

FIG. 5 is a block diagram illustrating another embodiment a mail server in a network having a plurality of device nodes for handling e-mails infected by computer viruses according to the invention.

### DETAILED DESCRIPTION OF PREFERRED EMBODIMENTS

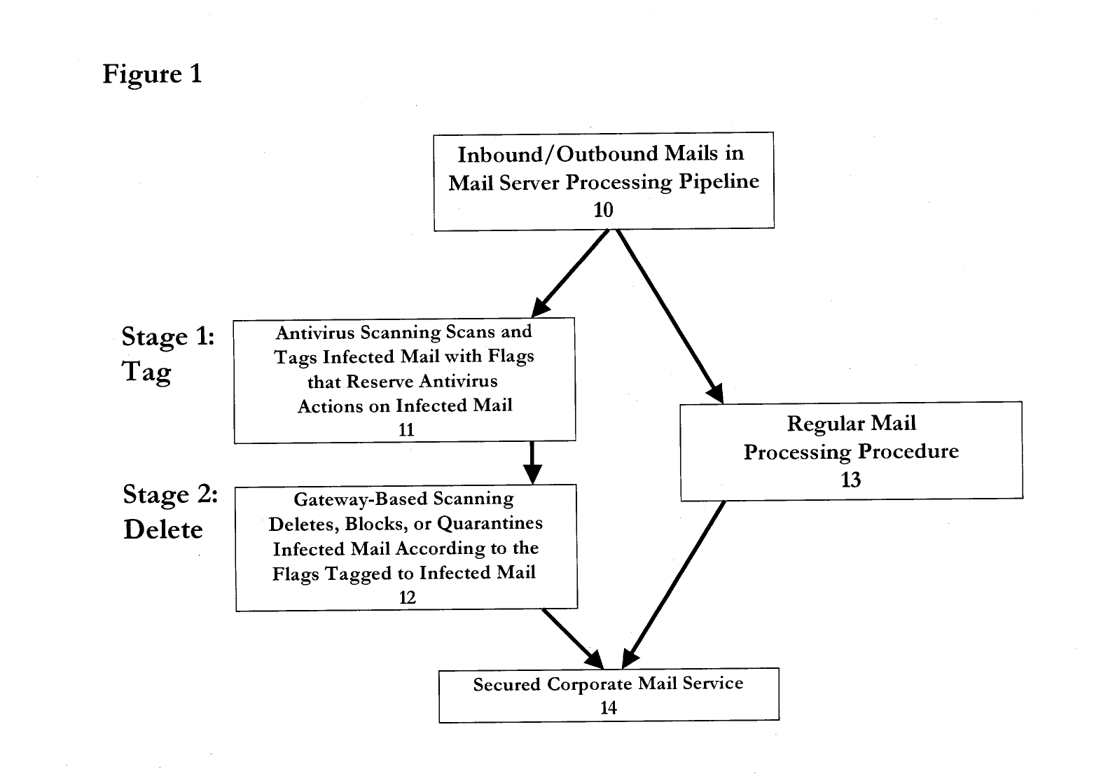

FIG. 1 is a block diagram that generally illustrates an antivirus methodology for handling electronic mails (e-mails) in a network according to the invention. According to a general embodiment of the method of the invention, the e-mails coming into or being transported out of a network are accordingly processed in a mail server therein (step 10). This general embodiment of the method of the invention includes two stages, tag (stage 1) and delete (stage 2). In stage 1, the inbound and outbound e-mails undergo an antivirus scan, where tags or designated flags (signature and corresponding antivirus action) are attached to those e-mails determined to have been infected by, or to be carrying, computer viruses (step 11). In stage 2, as all e-mails, including the tagged e-mails, pass through a mail gateway of the network in reaching their respective destinations. The tagged e-mails are identified according to their flags attached thereto, where corresponding antivirus actions are performed such as e-mail block, deletion or quarantine (step 12). For e-mails other than the tagged e-mails, standard mail processing is performed at the mail server (step 13). In accordance with the method of the invention, secured e-mail service is advantageously provided (step 14).

A preferred embodiment of the network system according to the invention with a mail server having a mail gateway a plurality of device nodes receiving and transmitting electronic mails (e-mails) through the mail gateway, a computer virus scanner in the mail server scanning the e-mails to determine if any of the e-mails are infected by computer viruses, a virus scanning control attaching flags to the infected e-mails and causing the infected e-mails to be transported through the mail gateway, a gateway scanner in the mail gateway identifying the infected e-mails through the attached flags and performing antivirus actions on the identified e-mails, where the antivirus actions are performed transparently to the plurality of device nodes in the network system. The network system according to the invention can further include a database storing the infected e-mails. The attached flags can further comprise a plurality of instructions, where the antivirus actions on the identified e-mails are performed according to the plurality of instructions. The plurality of instructions can further comprise subactions including deleting, blocking and quarantining the identified e-mails.

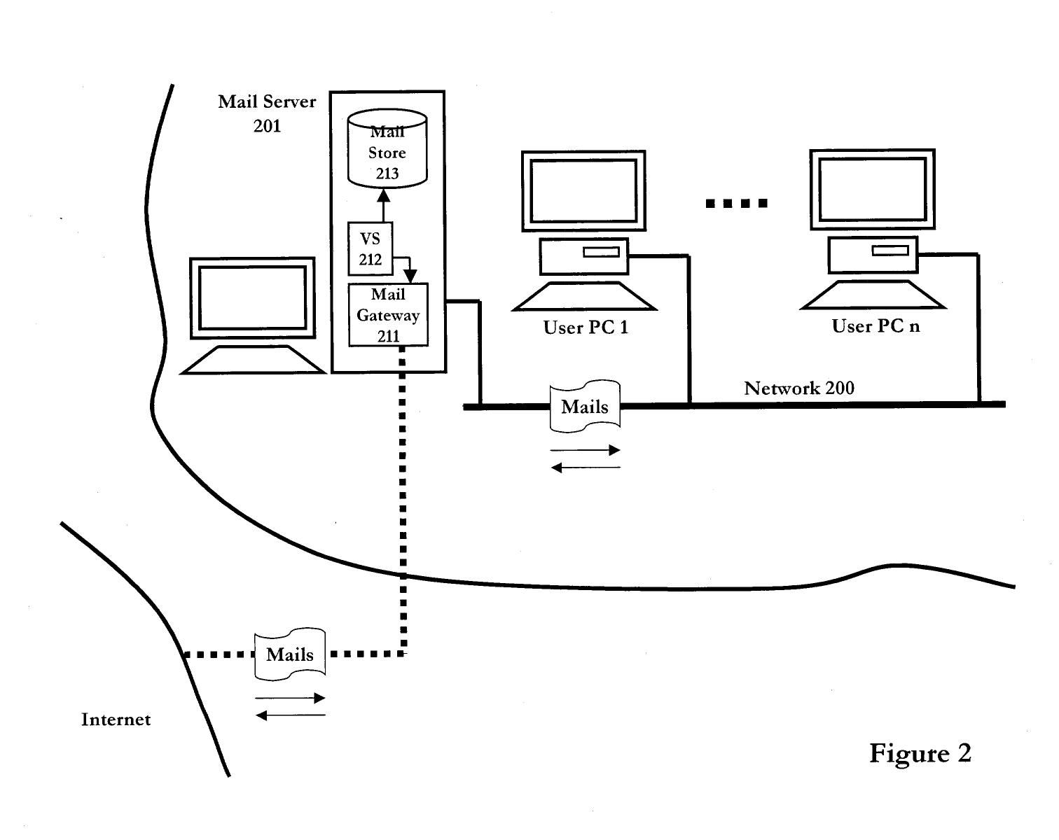

FIG. 2 is a block diagram that generally illustrates a network 200 connected to the Internet having a mail server 201 for handling e-mails for a plurality of device nodes 1, 2, . . . n in accordance with the invention. The network 200 according to this general embodiment of the invention comprises a plurality of device nodes (personal computers 1, 2, . . . n), and a mail server 201 handling e-mails coming into or going out of the network 200. The mail server 201 further comprises a mail gateway 211 as a first juncture between the network 200 and the Internet for handling e-mails therebetween. The mail server 201 also comprises a computer virus scanner 212 and mail storage 213.

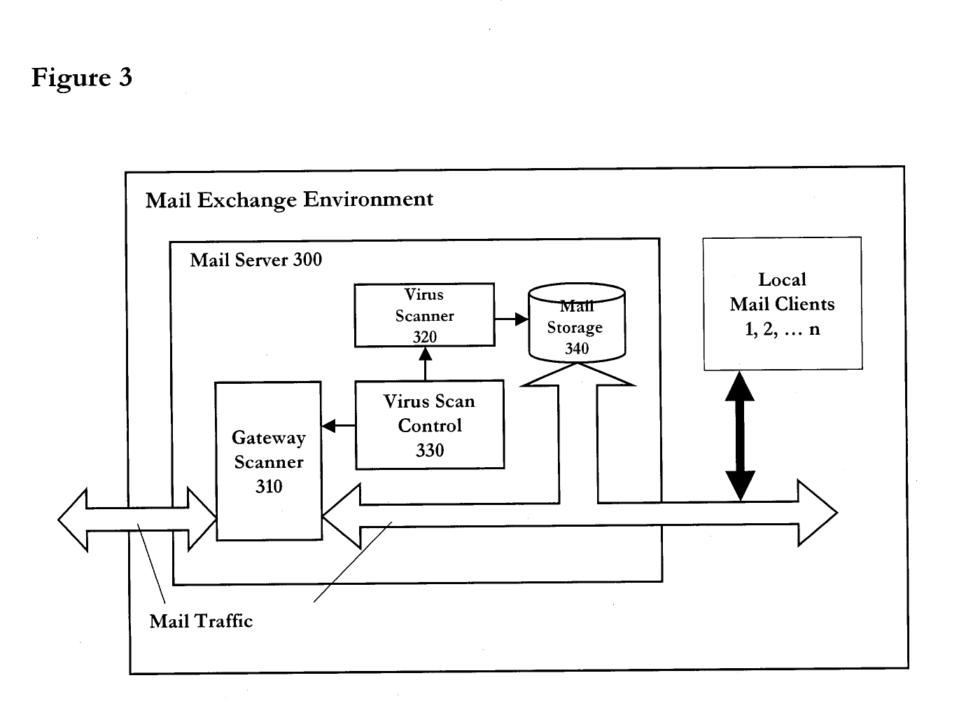

FIG. 3 is a block diagram that illustrates an exemplary mail server 300 for handling e-mails infected by computer viruses in a network (such as network 200) according to the invention. The mail server 300 according to this particular embodiment of the invention comprises a gateway scanner 310, computer virus scanner 320, virus scan control 330 and mail storage 340. E-mails directed to or coming from the local mail clients 1, 2, . . . n accordingly pass through the mail server 300 in reaching their respective destinations. The virus scanner 320 scan all of the e-mails passing through the mail server 300 in determining if any of the e-mails are infected by computer viruses. The virus scanning control 330 accordingly attaches flags (signature and designated antivirus actions) to the infected e-mails. The gateway scanner 310 in the mail gateway accordingly identifies the infected e-mails through the attached flags and accordingly performs, or causes to have corresponding antivirus actions performed on the identified e-mails. The mail storage 340 can store queued e-mails, or the infected e-mails if acting as quarantine. The attached flags can further comprise a plurality of instructions, where the antivirus actions on the identified e-mails are performed according to the plurality of instructions. The plurality of instructions can further comprise subactions including deleting, blocking and quarantining the identified e-mails. All of these antivirus actions and process steps are performed transparently to the plurality of device nodes 1, 2, . . . n.

In further embodiments according to the invention, the network 200 can further include an e-mail content filter scanning the headers and contents of the e-mails passing through the mail server 300. The network 200 can also comprise an e-mail filter scanning the attachments of the e-mails passing through the mail gateway. Moreover, the network 200 can include an anti-spamming filter scanning the inbound and outbound e-mails.

A preferred embodiment of the method according to the invention comprises the steps of determining if any of the e-mails are infected by computer viruses, attaching flags to the infected e-mails, transporting the e-mails, including the infected e-mails, through the gateway server, identifying the infected e-mails through the attached flags, and performing antivirus actions on the identified e-mails, where these process steps are performed transparently to the plurality of device nodes. The method according to the invention can further include the step of processing the infected e-mails according to instructions in the attached flags, where the instructions further include deleting, blocking and quarantining the infected e-mails.

In further embodiments, the method according to the invention can further include the step of determining if any of the inbound and outbound e-mails carry program code for computer virus infection. The method according to the invention can also include the step of scanning the headers or contents of the inbound and outbound e-mails. The method according to the invention can further comprise the step of scanning the attachments of the e-mails coming into or going out of the mail gateway.

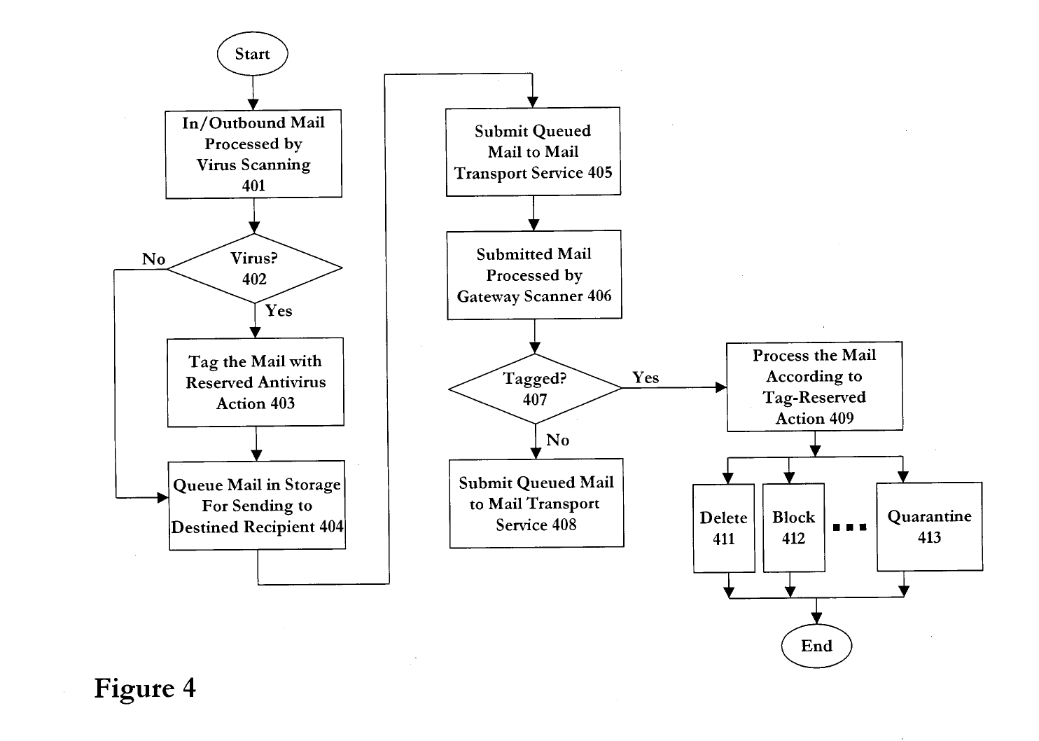

FIG. 4 is a flow diagram that illustrates a particular embodiment of the antivirus method for handling e-mails a network in accordance with the invention. In step 401, the inbound and outbound e-mails are scanned for computer viruses, e.g., by virus scanner 320. In step 402, it is determined whether any of the inbound and outbound e-mails carry or contain computer viruses. If it is determined that some of the e-mails are infected by computer viruses, the control is directed to step 403 where the infected e-mails are tagged with designated flags having corresponding signature and antivirus actions reserved therefor. For uninfected e-mails (as determined in step 402), the control flow is directed to step 404.

In step 404, the e-mails, including the tagged e-mails, are queued in the mail storage 340 for transmission to their respectively destined recipients in the network. As the queued e-mails are submitted to a mail transport service (step 405), the e-mails are processed by the gateway scanner 310 in step 406. In step 407, the e-mails are scanned, e.g., by the gateway scanner 310, to see if there are any tagged e-mails. If there are no tagged e-mails (as determined in step 407), the e-mails are forwarded to their respectively destined recipients by the mail transport service in step 408. If it is determined in step 407 that there are tagged e-mails, the tagged e-mails are processed in accordance with their attached flags (step 409), such as deleting (step 411), blocking (step 412) or quarantining the tagged e-mails (step 413).

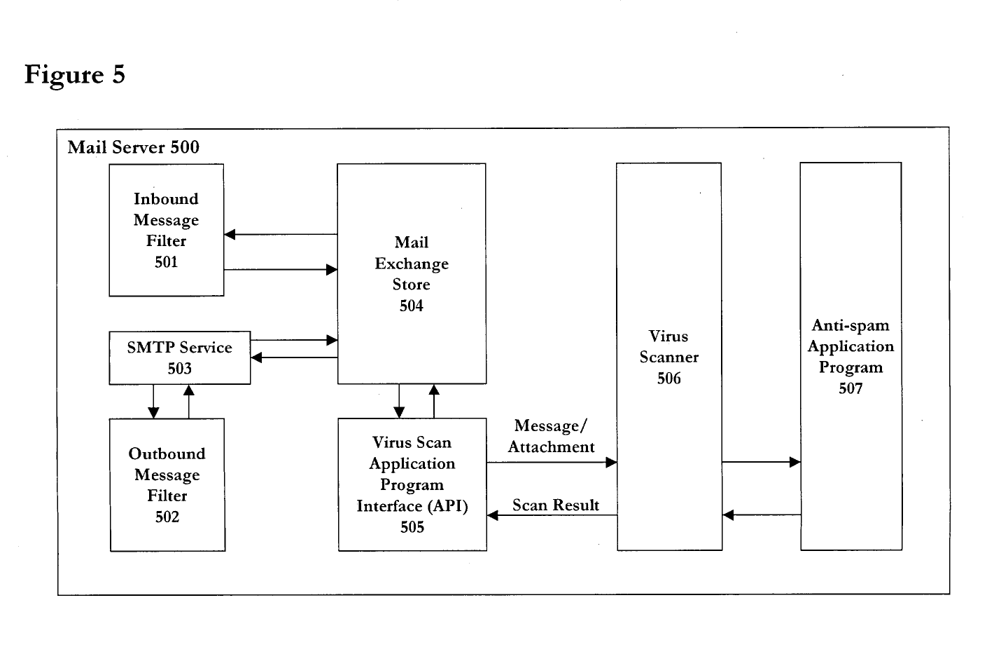

FIG. 5 is a block diagram illustrating another embodiment a mail server 500 in a network 200 having a plurality of device nodes 1, 2, . . . n for handling e-mails infected by computer viruses according to the invention. According to this particular embodiment of the invention, the mail server 500 comprises an inbound message filter 501, outbound message filter 502, standard mail transport protocol (SMTP) service 503, mail exchange store 504, virus scan application program interface (API) 505, virus scanner 506, and an additional mail application program 507. SMTP is a commonly deployed mail transport service for data networks for e-mail routing. E-mails directed to or coming from the local mail clients 1, 2, . . . n accordingly pass through the mail server 500 in reaching their respective destinations. The virus scanner 506 scans all of the e-mails passing through the mail server 500 in determining if any of the e-mails are infected by computer viruses. Flags (with signature and designated antivirus actions) are accordingly attached to the infected e-mails. The outbound message filter 502 at the mail gateway accordingly identifies the infected e-mails through the attached flags and accordingly performs, or causes to have corresponding antivirus actions performed on the identified e-mails. The mail exchange store 504 can store queued e-mails, or the infected e-mails if acting as quarantine. The attached flags can further comprise a plurality of instructions, where the antivirus actions on the identified e-mails are performed according to the plurality of instructions. The plurality of instructions can further comprise subactions including deleting, blocking and quarantining the identified e-mails. All of these antivirus actions and process steps are performed transparently to the plurality of device nodes 1, 2, . . . n. As the queued e-mails are submitted to the SMTP service 503, the e-mails are provided for scanning by the outbound message filter 502. If there are no tagged e-mails, the e-mails are forwarded to their respectively destined recipients by the SMTP service 503. If it is determined that there are tagged e-mails, the tagged e-mails are processed in accordance with their attached flags, such as deleting, blocking or quarantining the tagged e-mails.

The API 505, generally embedded and integrated in the mail server 500, scan the e-mails for computer viruses at the database level. All messages saved into a database in the network 200 will be scanned. The outbound message filter 502 scans the e-mails in conjunction with the active STMP service 503. The outbound message filter 502 advantageously block e-mail delivery or redirect e-mails in accordance with the scan results (e.g., if computer viruses are detected). In addition, the API 505 can access e-mails in the mail server for virus scan and antivirus processing such as deleting the infected e-mails (if appropriate). The application program 507 can further deploy anti-spamming functionalities on the fly, and also filter the contents of e-mails. At times, no single virus scanning program can fully implement, in totality, antivirus measures and content filtering. When the virus scanning at the mail exchange store 504 or virus scanner 506 has cleared certain infected e-mails but require other functionalities to take further antivirus actions on other e-mails, flags are attached to these other e-mails in instructing other functional components in the mail server 500 (such as outbound message filter 502 or API 505) to undertake further appropriate antivirus actions.

It would be apparent to one skilled in the art that the invention can be embodied in various ways and implemented in many variations. For instance, a network of computers is described herein in illustrating various embodiments of the invention. The invention is accordingly applicable in this and other types of networks, such as a metropolitan area network (MAN), a wide area network (WAN), a local area network (LAN) or even wireless communications networks for mobile phones and personal digital assistant (PDA) devices. Such variations are not to be regarded as a departure from the spirit and scope of the invention. In particular, the process steps of the method according to the invention will include methods having substantially the same process steps as the method of the invention to achieve substantially the same results. Substitutions and modifications have been suggested in the foregoing Detailed Description, and others will occur to one of ordinary skill in the art. All such modifications as would be obvious to one skilled in the art are intended to be included within the scope of the following claims and their equivalents.

We claim:

1. An antivirus method for a network system having a plurality of device nodes transmitting and receiving electronic mails (e-mails) through a gateway server, the method comprising the steps of:
(a) determining if any of said e-mails are infected by computer viruses;
(b) attaching flags to said infected e-mails;
(c) transporting said e-mails, including said infected e-mails, through said gateway server;
(d) identifying said infected e-mails through said attached flags; and
(e) performing antivirus actions on said identified e-mails.

2. The method of claim 1 further comprising the step of deleting said identified e-mails.

3. The method of claim 1 further comprising the step of blocking said identified e-mails from entering into said device nodes.

4. The method of claim 1 further comprising the step of quarantining said identified e-mails.

5. The method of claim 1 further comprising the step of processing said infected e-mails according to instructions in said attached flags, said instructions further comprising the substeps of deleting, blocking and quarantining said infected e-mails.

6. The method of claim 1 further comprising the step of scanning contents of said e-mails.

7. The method of claim 1 further comprising the step of scanning headers of said e-mails.

8. The method of claim 1 further comprising the step of scanning attachments of said e-mails.

9. The method of claim 1 further comprising the step of determining if any of said e-mails carry program code for computer virus infection.

10. The method of claim 1 wherein the steps (a), (b), (c), (d) and (e) are performed transparently to said device nodes in said network system.

11. A network system comprising:
a mail server having a mail gateway;
a plurality of device nodes receiving and transmitting electronic mails (e-mails) through said mail gateway;
a computer virus scanner in said mail server scanning said e-mails to determine if any of said e-mails are infected by computer viruses;
a virus scanning control attaching flags to said infected e-mails and causing said infected e-mails to be transported through said mail gateway;
a gateway scanner in said mail gateway identifying said infected e-mails through said attached flags and performing antivirus actions on said identified e-mails.

12. The network system of claim 11 further comprising a database storing said infected e-mails.

13. The network system of claim 11 wherein said antivirus actions are performed transparently to said device nodes in said network system.

14. The network system of claim 11 wherein said identified e-mails are deleted.

15. The network system of claim 11 wherein said identified e-mails are blocked from entering into said device nodes.

16. The network system of claim 11 wherein said attached flags further comprising a plurality of instructions wherein said antivirus actions on said identified e-mails are performed according to said instructions.

17. The network system of claim 16 wherein said instructions further comprise subactions including deleting, blocking and quarantining said identified e-mails.

18. The network system of claim 11 further comprising an e-mail content filter scanning headers and contents of said e-mails.

19. The network system of claim 11 further comprising an e-mail filter scanning attachments of said e-mails to determine if any of said e-mails carry program code for computer virus infection.

20. The network system of claim 11 further comprising an anti-spamming filter scanning said e-mails.
